(19) United States
(12) Patent Application Publication
(10) Pub. No.: US 2012/0119854 A1
(43) Pub. Date: May 17, 2012

(54) SEGMENTED TRANSMISSION SIGNAL CIRCUIT

(75) Inventor: Chih-Chuan Huang, Kaohsiung City (TW)

(73) Assignee: RAYDIUM SEMICONDUCTOR CORPORATION, Hsinchu (TW)

(21) Appl. No.: 13/196,572

(22) Filed: Aug. 2, 2011

(30) Foreign Application Priority Data
Nov. 16, 2010 (TW) 99139434

(51) Int. Cl. H01P 3/08; H01P 1/10

(52) U.S. Cl. 333/238; 333/262

(57) ABSTRACT

A segmented transmission signal circuit is provided with a parallel bus of data transmission. The bus includes a plurality of sections, each section transmits a corresponding parallel data of multiple bits, and the parallel data corresponding to different sections are in different bit orders.

This application claims the benefit of Taiwan Patent Application serial No. 99139434, filed Nov. 16, 2010, the subject matter of which is incorporated herein by reference.

### FIELD OF THE INVENTION

The present invention relates to a segmented transmission signal circuit, and more particularly, to a segmented transmission signal circuit transmitting parallel data with sections of different bit orders to improve transmission characteristics of parallel data.

### BACKGROUND OF THE INVENTION

Various kinds of signal circuits storing, controlling, managing and/or driving electric signals have become the most important hardware foundations of modern information society. Signal circuits are formed within chips/dice which are then packaged to integrated circuits.

In a signal circuit, a bus (or buses) is adopted for data transmission. For example, a signal circuit can include a front-end circuit providing an input parallel data and a back-end circuit driving the input parallel data for output; the front-end circuit transmits the parallel data to the back-end circuit through a parallel bus, so the back-end circuit can receive the parallel data provided by the front-end circuit.

In some applications, the back-end circuit drives output of many output terminals, so the back-end circuit is of a longer layout length; correspondingly, length of the bus has to be extended. For example, in an application of driving a display panel, a source driver is formed with a long rectangular layout, and therefore its internal signal circuit needs a longer bus for data transmission.

### SUMMARY OF THE INVENTION

A parallel bus includes a plurality of parallel data lines; each of the data lines transmits a bit of a parallel data. However, capacitive mutual coupling exists between the parallel data lines; the closer two data lines are, the stronger the coupling becomes, and therefore two adjacent data lines experience strong mutual coupling. The mutual coupling between two data lines affects data transmission characteristics of the two data lines; unit resistance of data lines and capacitive mutual coupling will form an RC network to delay data transmission.

Moreover, mutual coupling between two data lines affects data transition speed and time e.g., rise time and fall time. If two bits respectively transmitted on two data lines transit in a same direction (i.e., both bits transit from a first level to a second level), transition becomes faster due to constructive mutual coupling. On the contrary, if the two bits of the two data lines transit in different directions (one bit transits from a first level to a second level, and the other bit transits from the second level to the first level), transition will become slower due to destructive mutual coupling.

Because mutual coupling impacts transition time, bits of different data lines can not be transmitted with matched transmission characteristics, and parallel data transmission is therefore affected. For example, if transitions in same direction occur more frequently between a first data line and a second data line of a bus, and transitions in different directions happen more frequently between a third data line and a fourth data line of the bus, then bits transmitted on the first and the second data lines will gain better transmission characteristics (e.g., better set-up time and hold time), and bits transmitted on the third and fourth data lines suffer from worse transmission characteristics. Owing to the differences between the transmission characteristics, it is difficult for the back-end circuit to receive bits of data lines with a uniform standard.

As length of bus becomes longer and bit rate of parallel data increases, impacts due to mutual coupling between data lines become severe. To address the issues, one objective of the invention is provided which is called a segmented transmission signal circuit including a front-end circuit, a bus and a back-end circuit. The bus includes a plurality of sections; each section transmits a corresponding parallel data, and the parallel data corresponding to different sections are in different bit orders.

Each section of the bus includes a predetermined number of segments; each segment transmits a bit of the corresponding parallel data. The front-end circuit is coupled to the bus and provides an input parallel data to the bus, and the back-end circuit is coupled to the sections and receives the input parallel data from the sections.

In an embodiment, at least a switch routing is further included between the sections; each section is coupled between two corresponding sections, and switches bit order of the parallel data of one of the two corresponding sections to form the parallel data of the other of the two corresponding sections. For example, each segment of each section can correspond to an order, and the switch routing couples a segment of a first order in one section to a segment of a second order in the other section, where the first order is different from the second order.

Changing bit order of each section adjusts occurrences of transitions in same direction and transitions in different directions between two adjacent segments of a section. In a certain section, assuming a segment transmitting a given bit is adjacent to another segment with transitions mostly in different directions; as bit orders of different sections are switched, in the next section, a segment transmitting the given bit can be adjacent to another segment with transitions mostly in a same direction. Thus, for each bit, occurrences of transitions in same direction and transitions in different directions are dispersed, and transmission characteristics of bits can therefore approach uniformity.

Another objective of the invention is providing a segmented transmission signal circuit including a plurality of data lines and at least a switch routing. Each data line includes a plurality of segments, and each segment corresponds to a section. Each switch routing couples a segment corresponding to a first section in one data line to a segment corresponding to a second section in another data line; the first section is different from the second section.

The signal circuit of the invention can be adopted in applications of driving display panel, e.g., be implemented in a source driver chip, and the input parallel data can be a pixel color data of multiple bits.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior art) illustrates an embodiment of a bus;

FIG. 2 illustrates an embodiment according to the invention; and

FIG. 3 illustrates a generalized embodiment according to the invention.

### DETAILED DESCRIPTION OF PREFERRED EMBODIMENTS

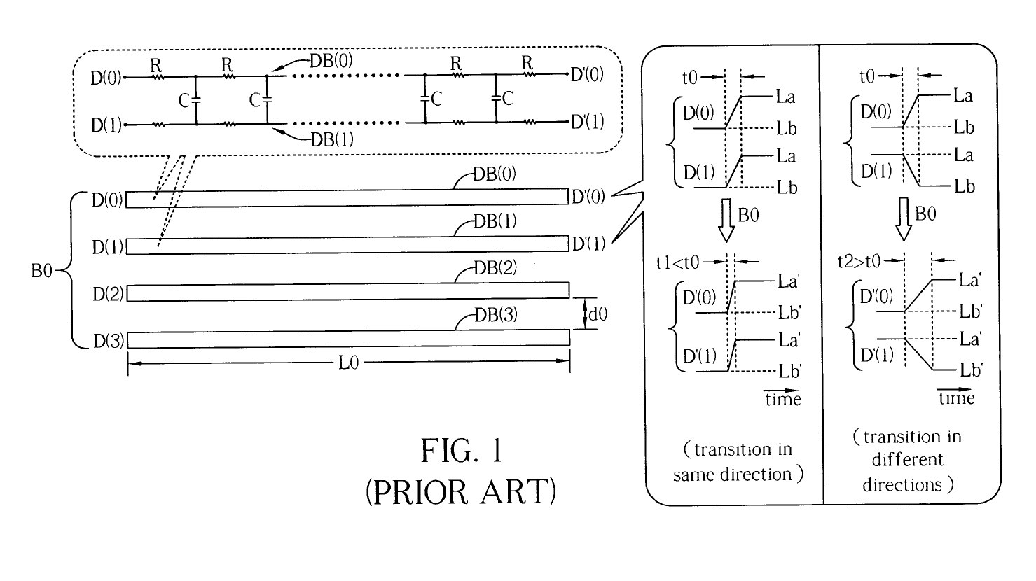

Please refer to FIG. 1 exemplarily illustrating an embodiment of a bus B0. As an example, the bus B0 transmits parallel data of four bits with four data lines DB(0) to DB(3); the four-bit parallel data includes four data bits D(0) to D(3) which are respectively transmitted by the data lines DB(0) to DB(3). It is recognized that more parallel data lines can transmit parallel data of more bits. Each of the data lines DB(0) to DB(3) is whole without being segmented, and is of a length L0 and an adjacent separation distance d0.

Taking the data lines DB(0) and DB(1) as an example, FIG. 1 also demonstrates how mutual coupling impacts data transmission. Within a unit length of the data lines DB(0) and DB(1), capacitive mutual coupling can be modeled by a capacitor C, and parasitic resistance existing on the data lines DB(0) and DB(1) are respectively modeled by resistors R. The capacitors C and resistors R form a RC network; when the data lines DB(0) and DB(1) respectively transmit the bits D(0) and D(1), the bits D(0) and D(1) are inputted into the RC network; as the bits D(0) and D(1) are transmitted through the bus B0, bits D′(0) and D′(1) outputted by the RC network are respective transmission results of the bits D(0) and D(1).

Due to mutual coupling between the data lines DB(0) and DB(1), transition speed and time of these two data lines are mutually affected. As shown in FIG. 1, if the bits D(0) and D(1) respectively transmitted by the data lines DB(0) and DB(1) simultaneously transit from a level Lb (e.g., a level of logic 0) to a level La (a level of logic 1) with a transition in same direction, then transition time decreases because of constructive mutual coupling. For the original bits D(0) and D(1), the transition time is reflected by an interval t0. After transmission of the bus B0, the transition time for the bits D′(0) and D′(1) transiting from a level Lb′ (e.g., a level representing logic 0) to a level La′ (a level of logic 1) will be shortened to an interval t1 with t1<t0.

On the contrary, when the bits D(0) and D(1) respectively transmitted on the data lines DB(0) and DB(1) transit in different directions, the transition time of the bits D′(0) and D′(1) increases due to destructive mutual coupling. On the data lines DB(0) and DB(1), the bit D(0) transits from the level Lb to the level La during the interval t0; at the same time, the bit D(1) reversely transits from the level La to the level Lb during the interval t0. However, when the bits D′(0) and D′(1) respectively respond transitions of the bits D(0) and D(1), the bits D′(0) and D′(1) need a longer interval t2 to respectively transit from the level Lb′ to the level La′ and from the level La′ to the level Lb′; i.e., t2>t0.

Because of mutual coupling between the data lines, bit transmission characteristics of the data lines mutually affect, thus the transmission characteristics of the data lines are not mutually matched, and parallel data transmission performance of the bus B0 is impacted. As the length L0 increases and/or the distance d0 decreases, mutual influence of the data lines becomes severe. In an integrated circuit, the length L0 of the bus B0 relates to layout arrangement of associated circuits within the integrated circuit, thus the length L0 only has a limited margin to be shortened. Increasing the distance d0 expands layout area occupied by the bus B0 and thus degrades integration of the integrated circuit. Buffers are adopted to improve transmission characteristics of buses in some technologies, but the buffers occupy additional layout area, increase power consumption, induce extra delays, and are incapable of improving mutual coupling between data lines.

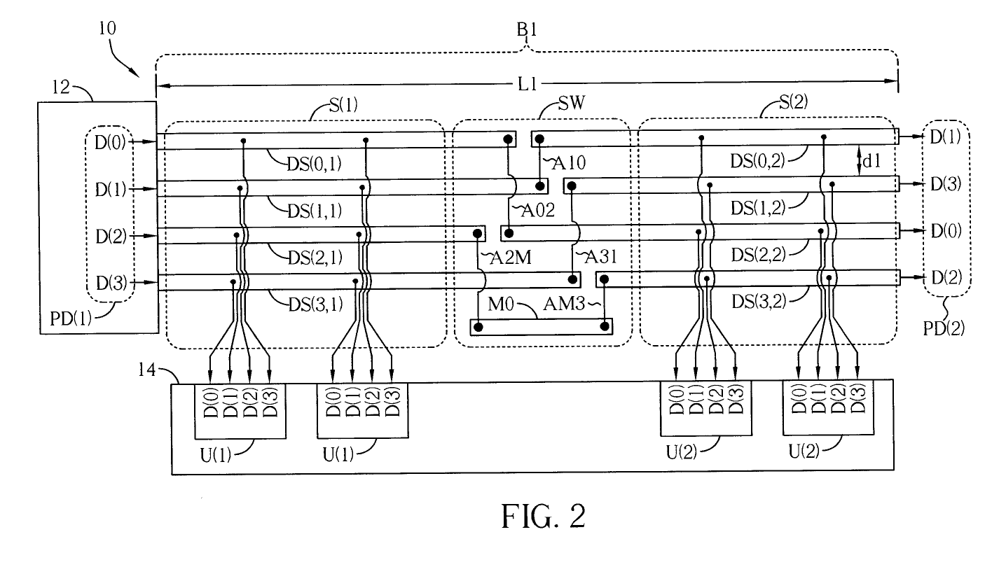

Please refer to FIG. 2 illustrating a bus B1 in a signal circuit 10 according to an embodiment of the invention. The signal circuit 10 is a segmented transmission signal circuit, and can be adopted in a chip, a die or an integrated circuit; the signal circuit 10 includes a front-end circuit 12 and a back-end circuit 14. The front-end circuit 12 is coupled to the bus B1 and provides a parallel data PD(1) to the bus B1 as an input parallel data; in the example of FIG. 1, the parallel data PD(1) includes bits D(0) to D(3) arranged in order. The bus B1 is of length L1 and transmits the bits D(0) to D(3) of the parallel data PD(1) to the back-end circuit 14.

To solve drawbacks of the bus B0 in FIG. 1, the bus of the invention includes a plurality of sections and associated switch routing(s) arranged between every two adjacent sections; each section transits a corresponding parallel data, and each switch routing coupled between two corresponding sections switches a bit order of the parallel data of one corresponding section to form the parallel data of the other corresponding section, such that parallel data of different sections are in different bit orders. In the example of FIG. 2, the bus B1 is divided to two sections S(1) and S(2) with a switch routing SW set in-between.

To transmit parallel data of four bits, the section S(1) includes segments DS(0,1), DS(1,1), DS(2,1) and DS(3,1); the section S(2) includes segments DS(0,2), DS(1,2), DS(2,2) and DS(3,2). Equivalently, the segments DS(0,1) and DS(0,2) respectively correspond to two sections of a same data line of an order “0”; the segments DS(1,1) and DS(1,2) belong to two sections of another data line and correspond to an order “1”. Similarly, the segments DS(2,1) and DS(2,2) correspond to two sections of a data line of an order “2”, and the segments DS(3,1) and DS(3,2) belong to two sections of a data line and correspond to an order “3”. The switch routing SW is utilized to couple segments corresponding to different orders in different sections and thus implements switching of bit orders.

In the exemplary embodiment of FIG. 2, the switch routing SW includes connections A10, A02, A31, A2M, AM3 and M0; the connection A10 couples the segment DS(1,1) of the section S(1) to the segment DS(0,2) of the section S(2), and the connection A02 couples the segment DS(0,1) to the segment DS(2,2). The connection A31 couples the segment DS(3,1) of the section S(1) to the segment DS(1,2) of the section S(2), and the segment DS(2,1) is coupled to the segment DS(3,2) by the connections A2M, M0 and AM3 of the switch routing SW. While implementing the bus B1, the segments DS(0,1) to DS(3,1), DS(0,2) to DS(3,2) and the connection M0 can be formed on a same conductive layer (e.g., a metal layer), and the connections A10, A02, A2M, A31 and AM3 can be formed on another conductive layer.

As shown in FIG. 2, through arrangement of the connections in the switch routing SW, the four-bit parallel data PD(1) transmitted in the section S(1) is originally formed in an order of the bits D(0), D(1), D(2) and D(3), but the parallel data PD(2) transmitted in the section S(2) is changed to be formed in an order of the bits D(1), D(3), D(0) and D(2). That is, the parallel data PD(1) and PD(2) respectively transmitted in the sections S(1) and S(2) are in different bit orders.

Changing bit order of each section adjusts occurrence of transitions in same direction and transitions in different directions between two adjacent segments of a section. Taking the bit D(0) as an example; in the section S(1), the bit D(0) is transmitted by the segment DS(0,1); because the segment DS(0,1) is adjacent to the segment DS(1,1), the data bits D(0) and D(1) affects each other due to mutual coupling. In the section S(2), however, the bit D(0) is changed to be transmitted by the segment DS(2,2) and the bit D(1) is changed to be transmitted by the segment DS(0,2). Since the segments DS(2,2) and DS(0,2) are no longer closely adjacent to each other, mutual influence of the bits D(0) and D(1) is reduced. That is, when the bit D(0) is transmitted on the bus B1, because the bit D(0) is adjacent to different bits in different sections, mutual coupling impacting the bit D(0) will be dispersively dependent on different bits instead of being dominated by a single bit D(1). Thus, transmission characteristics of the bit D(0) can be maintained at an average without tendency toward extremes (e.g., extremely short or long transition time).

In other words, in a certain section, a segment transmitting a given bit can be adjacent to another segment transmitting a bit with transitions mostly in different directions; owing to bit order switching between different sections, however, in the next section, a segment transmitting the given bit can be adjacent to another segment transmitting another bit with transitions mostly in same direction. Accordingly, when bits of the parallel data are transmitted, occurrences of transitions in same direction and in different directions are dispersed for each bit, and then the transmission characteristics of bits on the bus can approach uniformity.

The back-end circuit 14 can receive bits of the parallel data PD(1) from the sections S(1) and S(2). In the example of FIG. 2, the back-end circuit 14 receives the bits D(0) to D(3) transmitted in the section S(1) with circuit units U(1), and receives the bits D(0) to D(3) transmitted in the section S(2) with circuit units U(2). Number of circuit units corresponding to each section can be increased, decreased or omitted according to implementation needs.

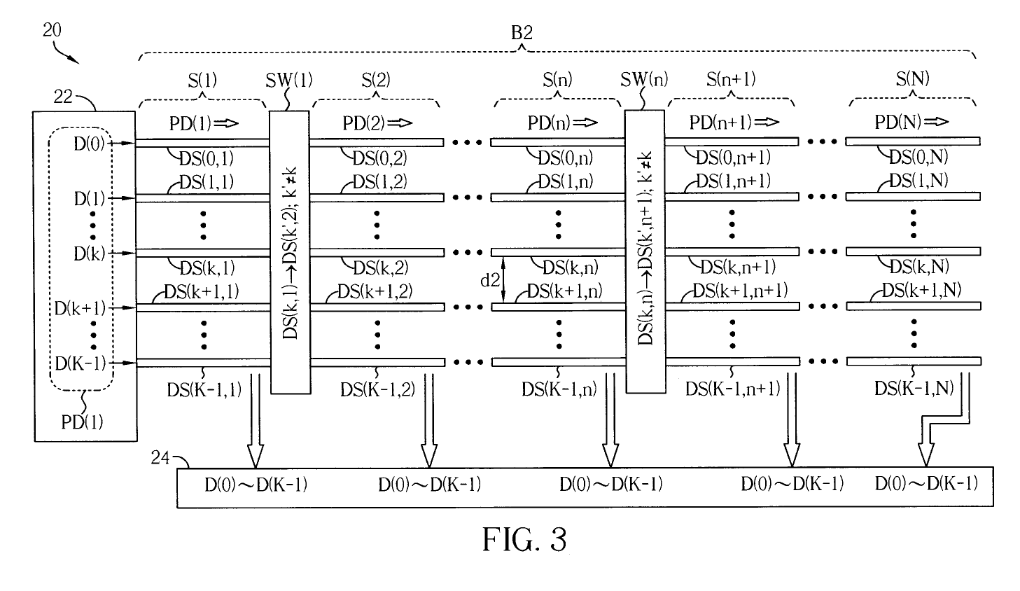

The embodiment shown in FIG. 2 according to the invention can be generalized, as shown in FIG. 3. FIG. 3 illustrates a bus B2 in a signal circuit 20 according to an embodiment of the invention. The signal circuit 20 is a segmented transmission signal circuit which can be implemented in a chip, a die or an integrated circuit, and includes a front-end circuit 22 and a back-end circuit 24. The front-end circuit 22 is coupled to the bus B2 and provides a parallel data PD(1) to the bus B2 as an input parallel data; in the example of FIG. 3, the parallel data PD(1) includes K bits D(0) to D(K−1) in order. The bus B2 transmits the bits D(0) to D(K−1) of the parallel data PD(1) to the back-end circuit 24.

The bus B2 includes sections S(1) to S(N), each section S(n) (with n=1 to N) transmits a corresponding parallel data PD(n). Each section S(n) includes K segments DS(0,n) to DS(K−1,n); each segment DS(k,n) (with k=1 to K) corresponds to an order “k” and transmits a bit, the parallel data PD(n) transmitted in the section S(n) is formed by the bits respectively transmitted on the segments DS(0,n) to DS(K−1,n) in order. For the sections S(1) to S(N), the segments DS(k,1), DS(k,2), . . . , DS(k,n), DS(k,n+1) to DS(k,N) corresponding to the same order “k” respectively belong to different sections of a same data line.

In the bus B2, a switch routing SW(n) (with n=1 to (N−1)) is included between every two adjacent sections S(n) and S(n+1). The switch routing SW(n) coupled between the sections S(n) and S(n+1) switches a bit order of the parallel data PD(n) of the section S(n) to form the parallel data PD(n+1) of the section S(n+1). For example, the switch routing SW(n) couples the segment DS(k,n) of the section S(n) to the segment DS(k′,n+1) of the section S(n+1) with connection(s), where k can be one of 0 to (K−1), k′ can be one of 0 to (K−1), and k′ is different from k. In this way, parallel data PD(n) and PD(n+1) are in different bit orders, hence bit transmission characteristics of the bus B2 can be improved.

The back-end circuit 24 can receive the bits D(0) to D(k−1) from one or more sections among the sections S(1) to S(N). Since mutual influence between bits can be effectively dispersed, a distance d2 between two adjacent segments DS(k,n) and DS(k+1,n) of two parallel data lines can be set to the minimal distance allowed by design rules of manufacturing. Similarly, the invention specially matches demands for long bus, such as source driver chips for driving display panels. The front-end circuit 22 of the signal circuit 20 receives parallel video signal from a video signal interface, obtains pixel color data in the video signal, and converts the pixel color data to the parallel data PD(1). Through the bus B2, the back-end circuit 24 receives the parallel data PD(1) to internal latch of each channel for display panel. Similar to the back-end circuit 14 in FIG. 2, the back-end circuit 24 can include a plurality of circuit units (not shown in FIG. 3); each circuit unit includes digital to analogue converter and/or driving amplifier etc, receives the bits D(0) to D(k−1) from a section, and provides driving power to pixel of display panel according to the bits D(0) to D(k−1).

To sum up, as bits of a parallel data are transmitted on a parallel bus, each bit is adjacent to different bits in different sections, such that mutual influence between bits can be dispersed and transmission characteristics of bus can be improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A segmented transmission signal circuit comprising:
a bus comprising:
a plurality of sections, each of the sections transmitting a corresponding parallel data, and the parallel data corresponding to different sections being in different bit orders.

2. The segmented transmission signal circuit as claimed in claim 1, wherein the bus further comprises:
at least a switch routing; each switch routing coupled between two corresponding sections of the plurality of sections, and switching the bit order of the parallel data of one of the two corresponding sections to form the parallel data of the other of the two corresponding sections.

3. The segmented transmission signal circuit as claimed in claim 2, wherein each of the sections comprises a predetermined number of segments with each of the segments corresponding to an order; each switch routing couples a segment of a first order in one of the two corresponding sections to a segment of a second order in the other of the two corresponding sections with the first order different from the second order.

4. The segmented transmission signal circuit as claimed in claim 1, wherein the sections are formed on a same conductive layer.

5. The segmented transmission signal circuit as claimed in claim 1 further comprising:
a front-end circuit being coupled to the bus and providing an input parallel data to the bus; and
a back-end circuit being coupled to the sections and receiving the input data from the sections.

6. The segmented transmission signal circuit as claimed in claim 5, wherein the input parallel data is a pixel color data of multiple bits.

7. A segmented transmission signal circuit comprising:
a bus comprising:
a plurality of data lines, each of the data lines comprising a plurality of segments with each of the segments corresponding to a section; and
at least a switch routing, each switch routing coupling one of the segments corresponding to a first section in one of the data lines to one of the segments corresponding to a second section in another one of the data lines; wherein the first section is different from the second section.

8. The segmented transmission signal circuit as claimed in claim 7 further comprising:
a front-end circuit being coupled to the bus and providing an input parallel data to the bus; and
a back-end circuit being coupled to the segments and receiving the input data from the segments.

9. The segmented transmission signal circuit as claimed in claim 8, wherein the input parallel data is a pixel color data of multiple bits.

10. The segmented transmission signal circuit as claimed in claim 7, wherein the segments are formed on a same conductive layer.
